(19) United States
(12) Patent Application Publication
(10) Pub. No.: US 2015/0097348 A1
(43) Pub. Date: Apr. 9, 2015

(54) MODULAR ACCESSORY ATTACHMENT SYSTEM FOR A UTILITY CART

(71) Applicant: Stanley Black & Decker, Inc., New Britain, CT (US)

(72) Inventors: Craig R. Steinfels, Powell, OH (US); Dale E. BAUMAN, Columbus, OH (US); Dustin M. Lee, Worthington, OH (US)

(73) Assignee: Stanley Black & Decker, Inc., New Britain, CT (US)

(21) Appl. No.: 14/191,565

(22) Filed: Feb. 27, 2014

Related U.S. Application Data
(60) Provisional application No. 61/886,792, filed on Oct. 4, 2013.

(51) Int. Cl. B62B 3/02; B62B 5/06; F16M 13/02; B62B 5/00

(52) U.S. Cl. CPC B62B 3/02; B62B 5/0006; B62B 5/064; F16M 13/02
USPC 280/47.35; 280/79.3; 211/162; 211/13.1; 224/401; 29/428

(57) ABSTRACT

Three different families of mobile utility cart accessories may be quickly and easily attached to a mobile utility cart of the present invention using the inexpensive, but flexible modular accessory attachment system of the present invention. This is accomplished by releasably slidably attaching the accessories to vertical rails mounted adjacent corner edges of the utility cart. The rails share fundamentally the same cross-section, and are continuous and uninterrupted, so that the accessories may be positioned at any vertical location on the rails, and consequently, on the utility cart. No complicated rail clamps are necessary. Instead, just two types of fastener subassemblies are needed to attach the accessories to slots in the rails. These accessories may include, for example, a tool holster of the present invention capable of snugly retaining up to three power tools on the cart.

### CROSS-REFERENCE TO RELATED APPLICATIONS

This Application claims priority from U. S. Provisional Patent Application Ser. No. 61/886,792, filed on Oct. 4, 2013, the disclosure of which is hereby incorporated by reference herein in its entirety.

### FIELD OF THE INVENTION

The present invention relates to utility carts, and particularly to systems for attaching accessories to utility carts and the like.

### BACKGROUND OF THE INVENTION

Mobile utility carts and boxes have become a mainstay in, among other areas, factories, assembly operations, construction sites, and particularly in vehicle repair and maintenance shops. There has arisen a parallel need for the operator to have access to one or more accessories while moving the mobile utility cart to various locations in the facility. These accessories include, for example, lights, parts containers, tool racks, diagnostic systems, and the like. To save time, it is preferable for such accessories to accompany the operator, but it is awkward for the operator to carry around the accessories during the course of his or her work. Accordingly, there consequently has arisen a need for a system for quickly and easily releasably attaching one or more of such accessories to the cart so that the operator may tailor the accessories which accompany the cart to the next job on the schedule.

One approach to solving this problem has been to attach accessories to mobile utility carts using discrete holes or fitments formed in the carts and/or in the accessories. However, such a system requires that particular accessories be attached only to particular locations on the carts, and restricts the operator's flexibility.

Therefore, there exists a need for a system which provides the operator with maximum flexibility to quickly and easily attach a large range of accessories to a mobile tool cart or the like, at a minimum cost.

### SUMMARY OF THE INVENTION

It has been discovered that it is in fact possible to provide a mobile utility cart, box, or even the wall of a shop with a modular accessory attachment system that uses two vertical rails having a single basic configuration to quickly slidably attach a wide range of accessories to the cart or wall, so that the accessories may be selectively positioned at any vertical position on the rails. By using fasteners having cross-sections complementary to the cross-sections of slots defined by the rails, it becomes possible to equip the accessories with such fasteners so that the fasteners slidably engage, and are trapped in, the slots. The coaction of an essentially single rail design of the present invention with the use of the fasteners of the present invention yields a user-friendly, highly-flexible modular accessory attachment system that is much less expensive, but easier to use, than existing proposals.

Accordingly, it is an object of the present invention to provide a modular accessory attachment system for attaching accessories to a substantially vertical surface, which uses two parallel vertical rails connected to the surface, which rails are continuous and uninterrupted, and which maintain a predetermined cross-section throughout the length of the rails, which rails trap fasteners, having complementary cross-sections to slots formed in the rails, for slidable movement in the slots so that accessories may be selectively releasably attached to the rails and positioned at any vertical location on the rails.

It is another object of the present invention to cause each rail to define a first longitudinal slot having a female fastener portion having a predetermined width, a transverse entry cavity opening outwardly of the rail and having a predetermined width less than the width of the female fastener portion, and a fastener clearance portion axially aligned with the transverse entry cavity.

It is still another object of the present invention to provide a first accessory defining a horizontal component having a predetermined width substantially spanning the distance between the two rails, the horizontal component further defining two rail interfaces operatively associated with respective rails, each rail interface including a first male fastener having a head and a shank and further including a first female fastener having a cross-section complementary to the cross-section of the first slot female fastener portion and being disposed in the first slot female fastener portion, and further being slidable up and down in the first slot; the shank of the first male fastener extending through the first accessory horizontal component so that the head engages the first accessory horizontal component and the shank further extends through the transverse entry cavity and into the first female fastener, the first female fastener being threadedly engageable with the first male fastener shank so that the first accessory may be selectively releasably attached to the rail and positioned at any vertical location on the rail.

It is a still further object of the present invention for each rail to define a second longitudinal slot oriented transverse to (rotated 90° from) the first slot such that when the rails are disposed on the vertical surface, their respective second slot entrance cavities face outwardly in opposite directions, whereby a second accessory having a second rail interface may be selectively releasably attached to the rail via fasteners slidably riding in the second slot and connected to the second rail interface in a manner similar to the connection of the first accessory to the first slot.

It is another object of the present invention for the first slots to be trapezoidal in cross-section, and for plural accessories to be attachable to the rails at the same time.

It is yet another object of the present invention to provide a mobile utility cart having four vertical sides defining four vertical edges having a predetermined height, two parallel vertical rails being connected to the cart adjacent respective vertical edges, where each rail defines first and second slots as noted above, whereby a first family of cart accessories can be selectively adjustably attached to the cart via the first slot in both parallel vertical rails and a second family of cart accessories may be selectively adjustably attached to the cart via the second slot in any of the vertical rails.

It is another object of the present invention to provide a mobile utility cart as noted above with two additional parallel vertical rails, whereby a third family of cart accessories may be selectively adjustably attached to the cart via the second slot in each of two parallel rails.

It is yet another object of the present invention to provide a mobile utility cart in which plural accessories from the first, second and third families of cart accessories may be adjustably attached to the cart at one time, and for accessories from the first and second families of cart accessories to be respectively adjusted freely up and down the rails without the accessories from the first family interfering with the accessories from the second family, and vice versa.

It is another object of the present invention to provide a mobile utility cart in which a vertically-elongated bumper is adjustably mounted on the rail via the second slot, where the bumper defines a generally U-shaped channel extending the length of the bumper, thereby defining a vertical slot in the inside face of the bumper having a predetermined width greater than the width of the rail, and the rail, bumper and first family of cart accessories being so configured as to permit the bumper and an accessory from the first family of cart accessories to be slidably attached to the rail independently of one another and without interfering with the ability of each to be slidable on the rail, so that the bumper and the cart accessory may be selectively adjustably attached to the cart at one time, and so that the bumper at least partially overlaps a side portion of the rail.

It is still another object of the present invention to provide a mobile utility cart having an adjustable handle having an elongated tubular member connected between two bracket members at each end, the bracket members being attachable to the rails via the first slots so that the tubular member is perpendicular to the rails, and so that the handle may be selectively slidably moved up and down the rails and releasably fastened at any selected vertical position thereon.

It is a still further object of the present invention to provide a mobile utility cart including a pivot mounting module releasably attachable to the rail second slot for selectively attaching accessories from the second family of cart accessories to the cart, including for example a lighting fixture, a cord wrap and an articulated aim system for mounting such objects as an electronic diagnostic center.

It is another object of the present invention to provide a mobile utility cart having creeper hangers operatively associated with the second slot in each of two parallel rails, the creeper hanger being adapted to be connected adjacent a long side of the cart and further being adapted to be clamped selectively to a creeper having either a tubular frame member or a rectangular frame member.

It is still another object of the present invention to provide a mobile utility cart having a tire holder operatively associated with the first slot, the tire holder including a tire holding bracket which may be selectively positioned in either a horizontal position or a vertical position by coaction of the tire holding bracket with a horizontal member defining two tubular attachment portions.

It is yet another object of the present invention to provide a method of attaching a mobile cart accessory to the mobile cart described above in which a subassembly of male and female fasteners connected to an accessory is positioned adjacent upper ends of respective rails so that the female fasteners are aligned with respective slots, the subassembly is lowered so that the female fasteners enter respective slots, the subassembly is moved along the rails to a desired position and then the fasteners are tightened to releasably hold the subassembly on the cart at the desired position.

It is a still further object of the present invention to provide a tool holster attachable to a substantially vertical surface (which may include the rails), in which the tool holster includes a frame adapted to be connected to the vertical surface and defining a horizontal bracket supporting a tool support portion, where the tool support portion defines a member angled outwardly and downwardly from the horizontal bracket, the member defining a recess having a configuration adapted to receive a tool, a resilient insert being mounted inside the recess and having a tool insertion aperture having a predetermined diameter, and further being configured to be complementary to the recess configuration, wherein the resilient insert has a continuous nose portion tapering downwardly from the tool insertion aperture a predetermined distance to an open end, the open end having a diameter smaller than the tool insertion aperture, whereby a tool may be inserted into the tool insertion aperture so that the tool snugly engages the nose portion.

Other features and advantages of the present invention will become apparent from the following description when viewed in accordance with the accompanying drawings and appended claims.

### BRIEF DESCRIPTION OF THE DRAWINGS

FIG. 1 is a perspective view of one embodiment of a mobile utility cart of the present invention, illustrating one embodiment of a modular accessory attachment system of the present invention.

FIG. 2 is a perspective view of another embodiment of a mobile utility cart of the present invention.

FIG. 3 is a side elevational schematic view of the mobile utility cart of FIG. 1

FIG. 4 is a front elevational schematic view of the mobile utility cart of FIG. 1.

FIG. 5 is an exploded perspective schematic view of the mobile utility cart of FIG. 1, illustrating the attachment of the vertical rail system of the present invention.

FIG. 6 is an exploded perspective view of the mobile utility cart of FIG.5, illustrating the attachment of one embodiment of a tool holster of the present invention.

FIG. 7 is an exploded perspective schematic view of another embodiment of the mobile utility cart of the present invention, illustrating the attachment of the vertical rails and one embodiment of a tool holster of the present invention.

FIG. 8 is an exploded schematic perspective view of the modular accessory attachment system of the present invention attached to the wall of a shop, illustrating the attachment of one embodiment of a tool holster of the present invention.

FIG. 9 is an exploded partial perspective schematic view of a rail of the present invention illustrating the use of fasteners according to the present invention in slots formed in the rail.

FIG. 10A is a top plan view of the rail of FIG. 9 with the fasteners shown attached to the rail via two slots.

FIG. 10B is a top plan view of the rail of FIG. 9 with the fasteners removed from the rail.

FIG. 10C is a top plan view similar to FIG. 10A, but illustrating the use of a slot which slidably accepts the head of a male fastener, rather than the female fastener.

FIG. 10D is a top plan view of the rail of FIG. 10C with the fasteners removed from the rail.

FIG. 11 is a top schematic perspective view of the rail of FIG. 9 showing the fastener subassemblies inserted in their respective slots.

FIG. 12 is a schematic perspective illustration of a first family of mobile utility cart accessories, in which:

FIG. 12A is a tool holder;

FIG. 12B is a parts container;

FIG. 12C is a combination parts bin and tool holder;

FIG. 12D is a tray and tool holder;

FIG. 12E is a waste basket holder;

FIG. 12F is a holder for parts bins;

FIG. 12G is a bottle or cup holder;

FIG. 12H is a tool holster; and

FIG. 12I is a holder for storing large fluid containers.

FIG. 13 is a top perspective schematic detail view of the rail system of the present invention to which are attached a bumper accessory of the present invention and a tool holster accessory of the present invention, each being slidably positionable on the rails independently of one another.

FIG. 14 is an enlarged perspective schematic detail view, taken from the rear, of the rail system, bumper and tool holster of FIG. 13, and illustrating the insertion of a bumper/fastener subassembly of the present invention and the tool holster/fastener subassembly of the present invention into respective slots in the rails.

FIG. 15 is a perspective detail view of another embodiment of the tool holster of the present invention.

FIG. 16 is an enlarged perspective schematic detail view of the rail system of the present invention, showing one embodiment of a handle accessory according to the present invention being attached to the rails at the same time a tool holster accessory of the present invention is also attached to the rails.

FIG. 17 is an enlarged perspective detail view, taken from above, showing one embodiment of a rail of the present invention attached to one embodiment of a utility cart of the present invention, while illustrating the trapezoidal and rectangular cross-sections (shown in phantom) of the first and second slots of the rails of the present invention, and further illustrating one embodiment of a bumper accessory according to the present invention attached to the rail at the same time as a handle accessory according to the present invention.

FIG. 18 is a bottom plan schematic view of the utility cart of the present invention shown in FIG. 4.

FIG. 19 is an enlarged bottom plan detail view of the circled portion of FIG. 18.

FIG. 20 is a perspective schematic detail view of a hose reel accessory according to the present invention attached to a rail according to the present invention.

FIG. 21 is an enlarged perspective schematic view of three accessories taken from the first group of utility cart accessories and being attached to the first slots in the rails according to the present invention.

FIG. 22 is a schematic perspective detail view of a tire holder accessory according to the present invention being attached to rails according to the present invention.

FIGS. 23 and 24 are perspective schematic detail views of the tire holder of FIG. 22, showing the tire holder in its folded and deployed states, respectively.

FIGS. 25 and 26 are enlarged perspective detail views of the tire holder accessory shown in FIGS. 23 and 24.

FIG. 27 is an enlarged exploded perspective detail view of an articulated arm system accessory of the present invention being attached to a pivot mounting module according to the present invention.

FIG. 28 is a perspective schematic detail view, taken from the top, of the articulated arm and pivot mounting module subassembly of FIG. 27 attached to a rail according to the present invention.

FIG. 29 is a partial detail view taken from the rear of the subassembly and rail shown in FIG. 28.

FIG. 30 is a perspective schematic detail view of a wire wrap accessory according to the present invention.

FIG. 31 is a perspective schematic view of one embodiment of the utility cart according to the present invention to which is attached a lighting fixture according to the present invention via a pivot mounting module and rail system of the present invention.

FIG. 32 is an enlarged schematic detail view of the lighting fixture of FIG. 31, showing the lighting fixture lowered to a different elevation relative to the mobile utility cart of the present invention.

FIGS. 33 and 34 are perspective schematic views of an articulated tray system accessory according to the present invention.

FIGS. 35 and 36 are perspective detail views of creeper hangers of the present invention attaching two types of creepers to the rail system of the present invention.

FIGS. 37 and 38 are enlarged schematic perspective detail views of a creeper hanger according to the present invention.

FIG. 39 is an enlarged schematic detail view of a trapezoidal fastener subassembly according to the present invention.

FIG. 40 is a partial schematic perspective detail view of an accessory/fastener subassembly being positioned above the top of two parallel rails according to the present invention, preparatory to attaching the accessory to a mobile tool cart of the present invention.

FIG. 41 is an enlarged perspective detail view of the accessory/fastener subassembly being inserted into a slot of the rail of the present invention.

### DETAILED DESCRIPTION OF THE PREFERRED EMBODIMENTS

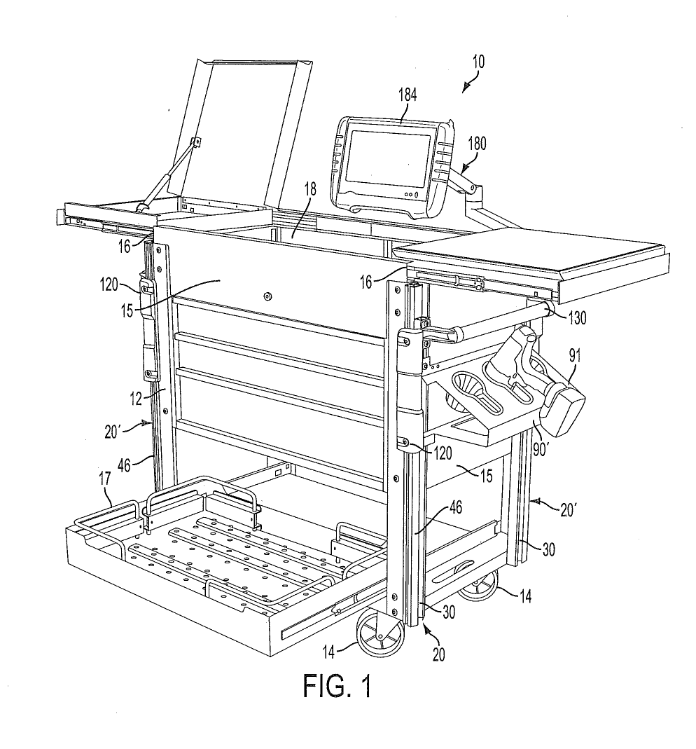

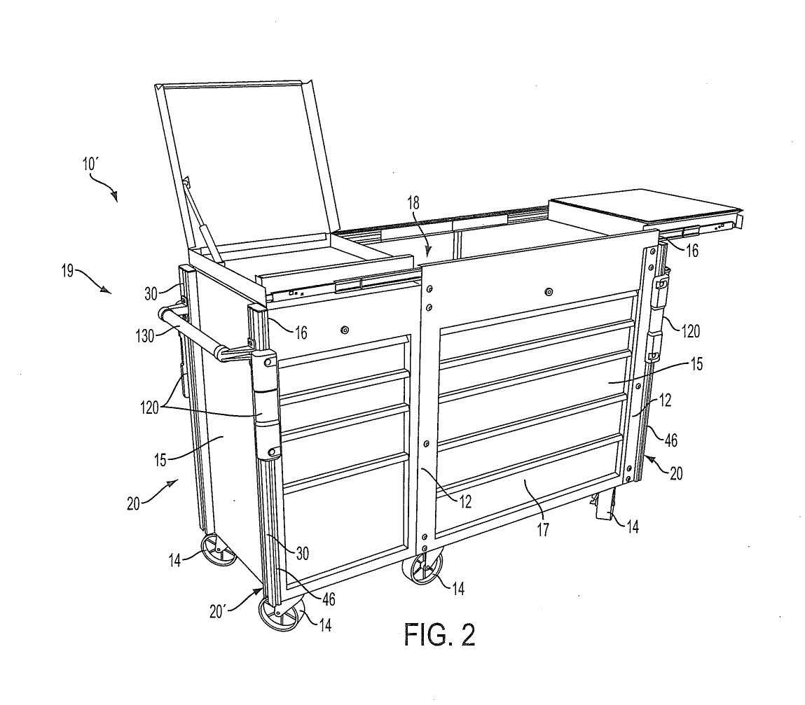

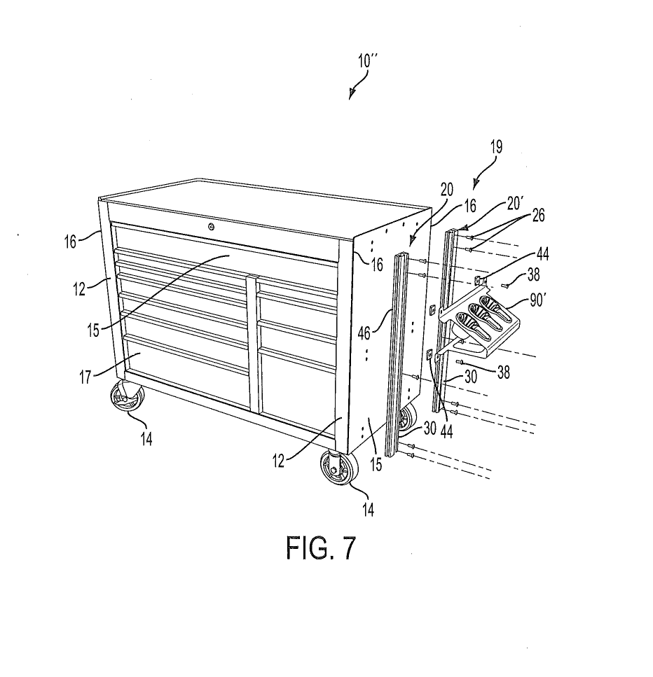

FIGS. 1, 2 and 7 show three embodiments of a utility cart 10, 10′, 10″ according to the present invention. As used herein, the phrase “utility cart” also includes “utility box”, and any other conveyance for use in and around a factory, shop, construction site, or other work environment.

As shown in FIGS. 1, 2 and 7, the utility cart 10, 10′, 10″ of the present invention includes a support structure 12 which itself is supported on four or more wheels or casters 14. The support structure 12 defines four sides 15, which in turn define vertical corner edges 16. If desired, the utility cart 10, 10′, 10″ can include drawers 17 and a storage space 18.

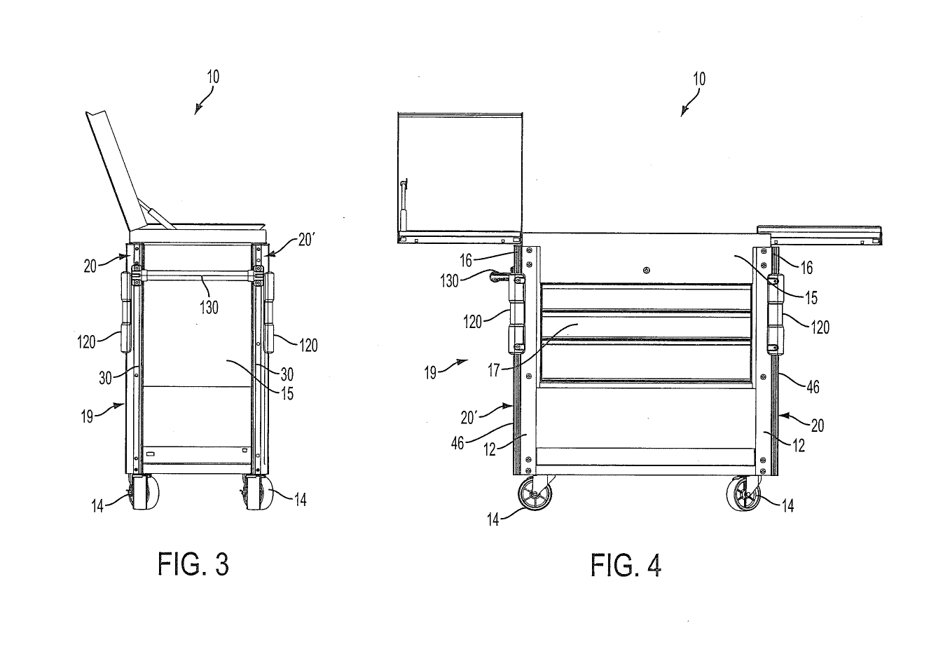

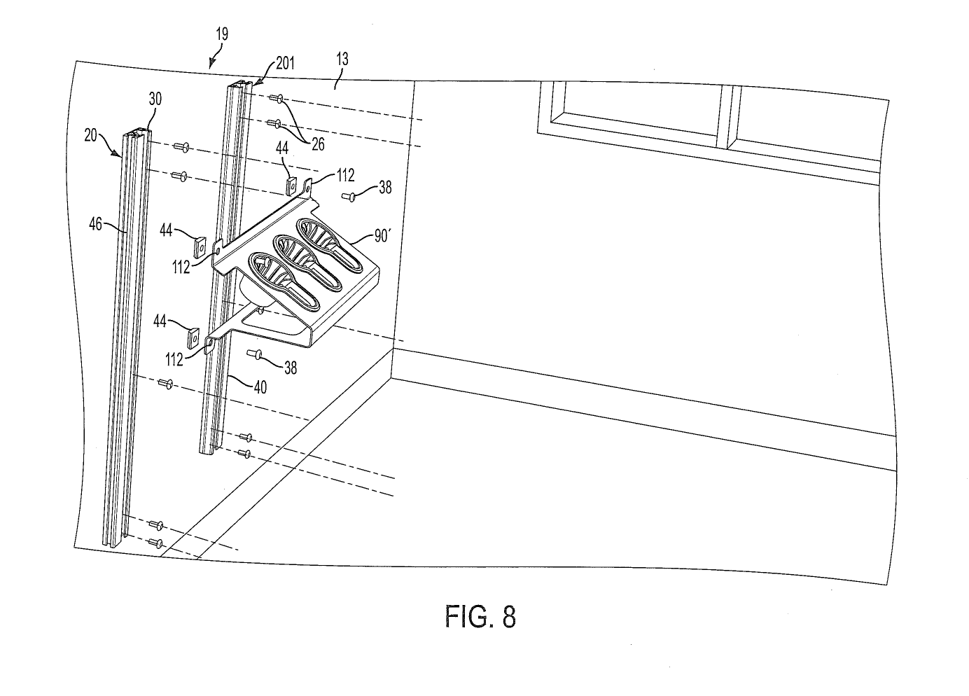

Referring now to FIGS. 1 through 11, a modular accessory attachment system 19 according to the present invention may be used in conjunction either with the utility carts 10, 10′, 10″ of the present invention, or as attachments to the wall 13 of a shop as shown in FIG. 8, or to another substantially vertical surface. The modular accessory attachment system 19 according to the present invention includes a rail system, a cart accessory, and a rail interface connecting the cart accessory to the rail system. The rail system of the present invention includes two vertically-oriented parallel rails 20, 20′ spaced a predetermined distance apart, and disposed adjacent respective vertical corner edges 16 of the cart. Each rail 20, 20′ is continuous and uninterrupted and maintains a predetermined cross-section throughout the length of the rail. Rail 20 is a “left-hand” rail for mounting adjacent a left-hand corner edge 16 of a side 15, and rail 20′ is a “right-hand” rail for mounting adjacent a right-hand corner edge 16 of the side 15. As will be seen, the rails 20, 20′ are mirror images of one another, so that the discussion that follows of the structure of one rail will apply equally to the structure of the other. Preferably the rails 20, 20′ are formed of extruded aluminum.

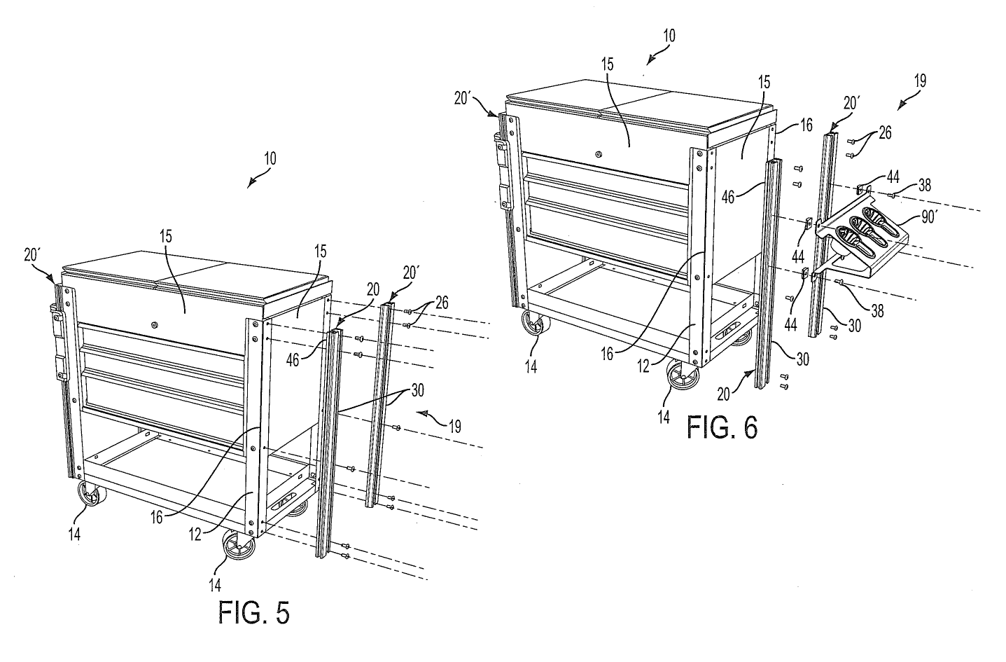

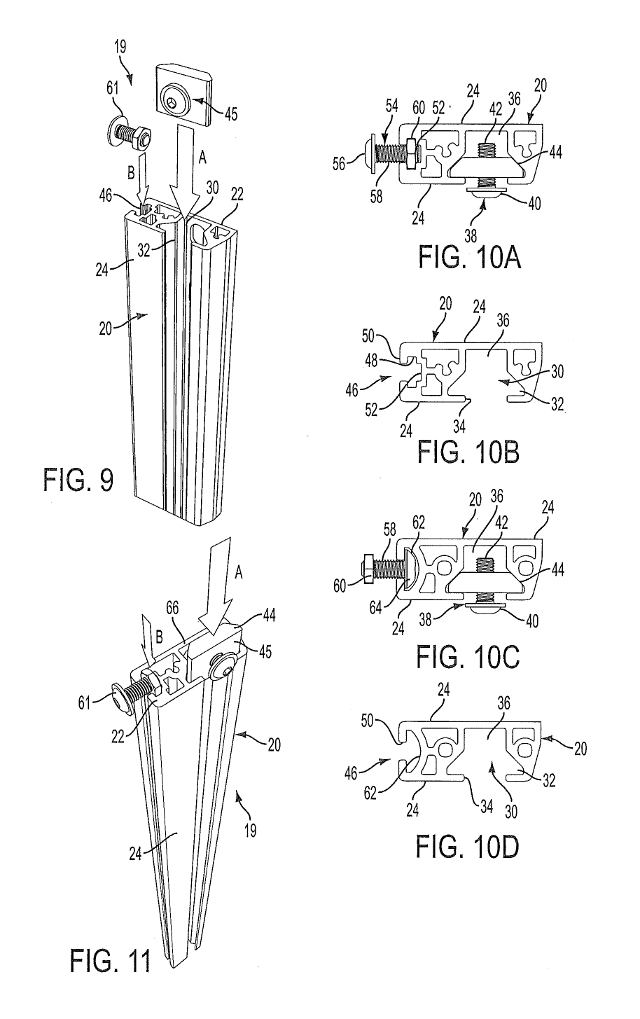

As shown in FIGS. 9, 10A through 10D, and 11, rail 20 has an upper end 22 and side surfaces 24, and, as shown in FIGS. 5-8, the rails 20, 20′ are attached to the mobile utility cart 10, 10′, 10″ or other substantially vertical surface 13 with fasteners 26. Still referring to FIGS. 9-11, each rail 20 defines a first longitudinal slot 30, which has a predetermined cross-section. According to one embodiment of the modular accessory attachment system 19 of the present invention, the cross-section of the first slot 30 includes a trapezoidal female fastener portion 32 having a predetermined width, whose long side is adjacent a transverse entry cavity 34, the entrance cavity having a predetermined width less than the width of the female fastener portion. The first slot 30 also defines a fastener clearance portion 36. The interface connecting an accessory of the modular accessory attachment system 19 of the present invention to the rails 20, 20′ includes a first male fastener 38 having a head 40 and a shank 42, which is threadedly engageable with a first female fastener 44, thereby forming a first fastener subassembly 45. The female fastener 44 has a cross-section complementary to the cross-section of the female fastener portion 32 of the first slot 30. Accordingly, in one embodiment of the modular accessory attachment system 19 of the present invention, the cross-section of the female fastener 44 is trapezoidal, so that the female fastener is trapped for slidable movement up and down in the first slot 30. Other configurations for the first slot cross-section may be used; however, it has been found that the trapezoidal cross-section as described above provides good structural stability and connection strength with the various accessories mounted on the rails 20, 20′.

One of the features of the present invention is the provision in the rail 20 of a second longitudinal slot 46, oriented in a direction orthogonal to that of the first longitudinal slot 30. This makes it possible to slidably attach a plurality of additional accessories to the cart 10, 10′, 10″ using the same rail 20. It also makes it possible to attach accessories which are oriented to the cart 10, 10′, 10″ in a different direction than those attached to the first slot 30. Thus the modular accessory attachment system 19 of the present invention provides an operator with flexibility not only in being able to position an accessory at any point vertically along the rails 20, 20′ (and not being limited to using discrete holes), but also in being able to attach different families of accessories to the same rails, as will be discussed below.

With continued reference to FIGS. 9 through 11, each rail second longitudinal slot 46 defines a second female fastener portion 48 having a predetermined width and cross-section and a transverse entry cavity 50 which opens outwardly of the rail 20, where the second slot entrance cavity 50 has a predetermined width less than the width of the second female fastener portion 32. Coaxial with the second slot entrance cavity 50 is a second slot fastener clearance portion 52. A second rail interface includes a second male fastener 54 having a head 56 and a shank 58, which is threadedly engageable with a second female fastener 60 to form a second fastener subassembly 61. The second male fastener head 60 is configured to be slidably trapped within the second slot 46, as shown in FIGS. 9 and 10A. Note that the shanks 42, 58 of respective male fasteners 38, 54 are permitted to protrude inwardly of their respective female fasteners 44, 60 by virtue of their respective fastener clearance portions 36, 52.

Another embodiment of the second rail interface is shown in FIGS. 10C and 10D. If desired, instead of configuring the second slot female fastener portion 48 to accept a female fastener 60, it may be configured to have a cross-section which is complementary to the cross-section of a male fastener head 64, so that the head is trapped for slidable movement up and down the second slot 48. Accordingly the female fastener 60 protrudes outwardly from the rail 20 and is adapted to engage an accessory.

Referring to FIG. 9, the fastener subassemblies 45, 61 can now be positioned above the upper end 22 of the rail 20 so that the female fasteners 45, 61 are aligned, respectively, with the first and second longitudinal slots 30, 46. Next, the fastener subassemblies 45, 61 may be lowered, as indicated by arrows A and B, into their respective slots 30, 46, as shown in FIG. 11. It can be appreciated that if the fastener subassemblies 45, 61 were attached to respective accessories, the accessories could be freely moved up and down the rails 20, 20′ and be releasably attached at any point along the rails by tightening the respective fastener subassemblies.

Referring for the moment to FIGS. 1, 2, 4 and 13, the right-hand rails 20′ are disposed on the cart 10, 10′, 10″ adjacent respective vertical corner edges 16 so that their respective second longitudinal slots 46 face outwardly in a direction opposite to the direction in which the second slots of the first rail 20 face. In one embodiment of the modular accessory attachment system 19 of the present invention, two sets of parallel vertical rails 20, 20′ may be attached to the cart 10, 10′, 10″, one set being attached at each end of the cart. If desired, and depending upon the configuration of the cart or the substantially vertical surface to which the rails 20, 20′ are to be attached and the types of accessories to be used, fewer or greater than four rails may be employed.

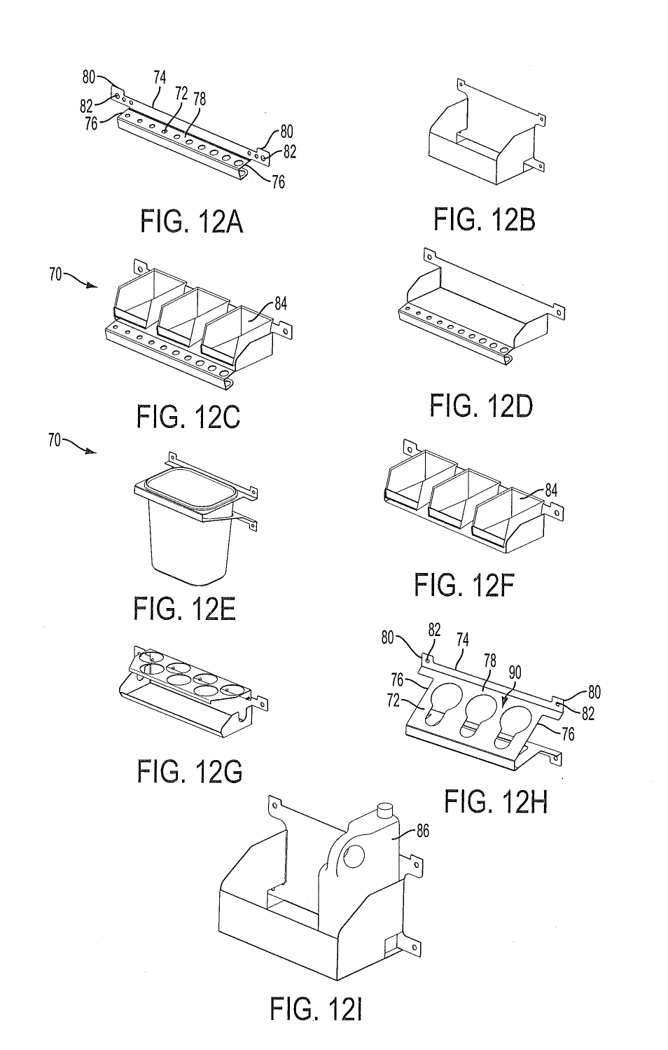

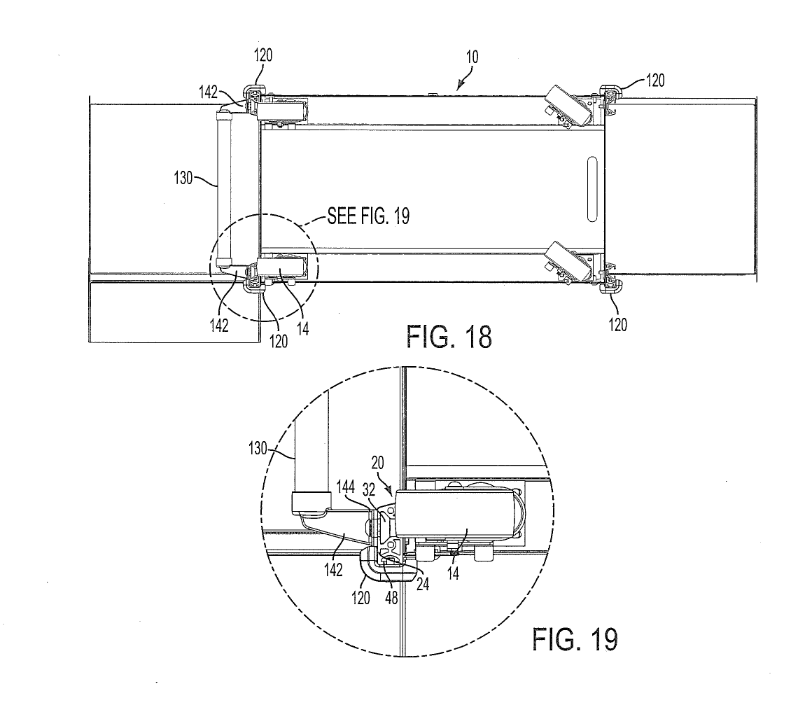

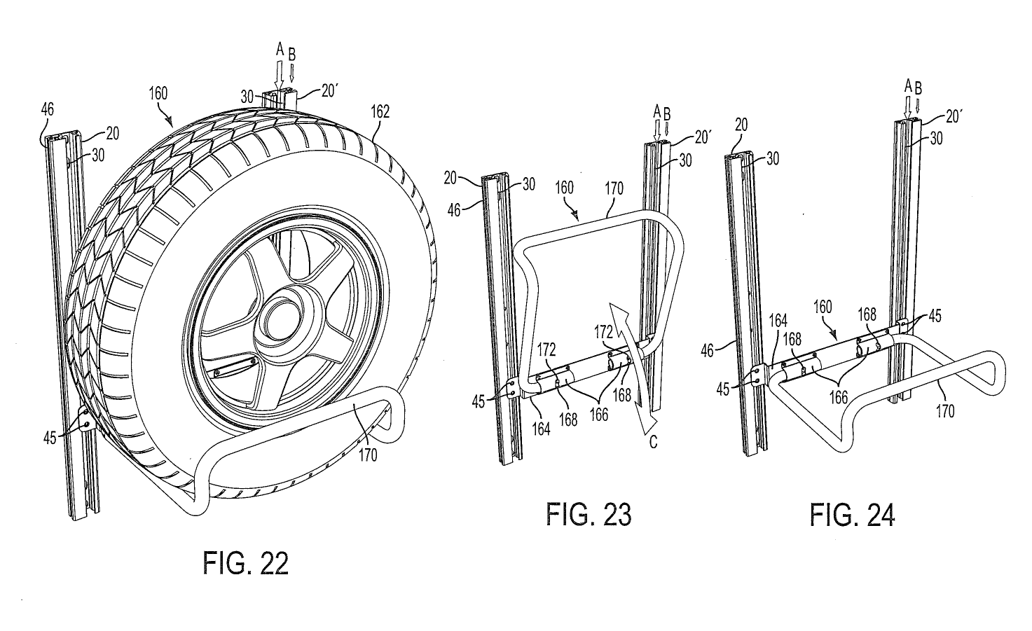

As shown in FIGS. 1-4, 6, 7, 8, 12-19, 21, and 22-26, a whole family of mobile tool cart accessories may be attached to a substantially vertical surface via the first slot 30 of a set of two vertical rails 20, 20′. This first family 70 of accessories may, if desired, share very similar characteristics, which characteristics contribute to the modularity of the accessory attachment system 19 of the present invention. For example, FIGS. 12A- 121, respectively, illustrate nine different accessories in this first family, namely: a toolholder; a parts containers; a combination parts bin and toolholder; a tray and toolholder; a waste basket holder; a holder for parts bins; a bottle or cup holder; a tool holster; and a holder for storing large fluid containers. It can be seen that all of the accessories from this first family possess certain common features to, for example, the tool holder shown in FIG. 12A. Each accessory defines a functional portion 72 and a horizontal component or bracket portion 74, the functional portion and the bracket portion, in one embodiment, being formed as a single sheet metal unitary structure. The functional portion 72 has a first predetermined width, two ends 76 and a top 78. The bracket portion 74 has a second predetermined width greater than the first predetermined width and is disposed adjacent the top 78 of the functional portion 72. The bracket portion 74 also defines two ends 80 extending outwardly of the functional portion ends 76. Each bracket portion end 80 defines an attachment hole 82. The horizontal distance between centerlines of respective attachment holes 82 is selected to be substantially equal to the distance between centerlines of respective first slots 30 of a set of rails 20, 20′. As a result of the coaction of these parameters, the many accessories selectable from the first family 70 are stably supported upon, but their respective functional portions 72 are located inside of, the rails 20, 20′. That also ensures that accessories attached to the cart 10, 10′, 10″ via the second slot 46 do not interfere with the positioning and movement of accessories attached to the cart via the first slot 30 (namely accessories selected from the first family of utility cart accessories), and vice-versa.

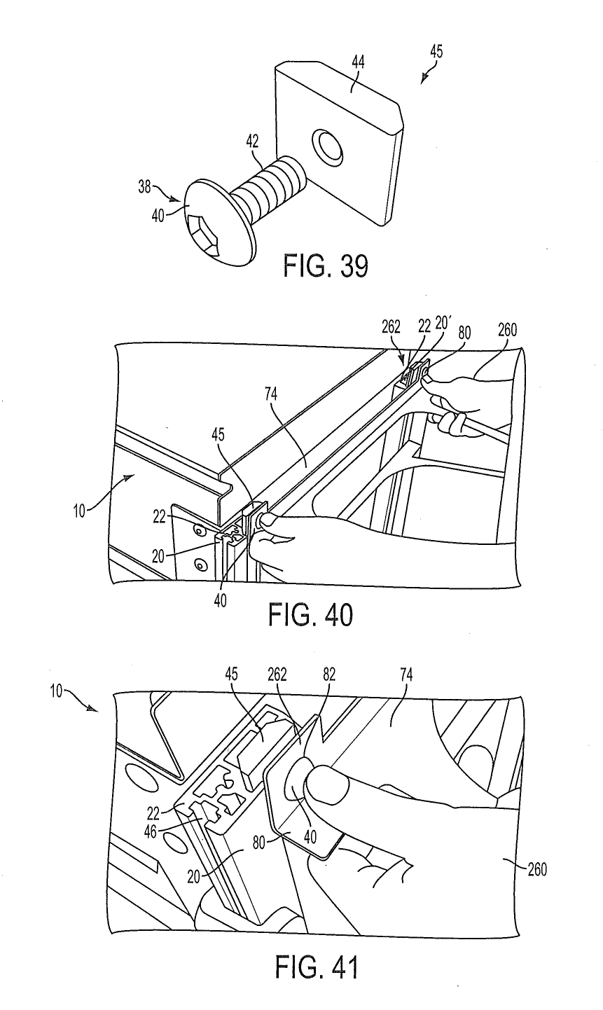

The first male fasteners 36 may be inserted in respective attachment holes 82 so that the male fastener heads 40 engage respective bracket portion ends 80, and the male fastener shanks 42 may now be inserted into respective transverse entry cavities 34 to threadedly engage respective female fasteners 44 to create a fastener and accessory subassembly, but leaving enough slack in the fastener threads to maneuver the subassembly into place in the rail slots. As illustrated in FIGS. 39-41, an operator 260 may position the subassembly 262 of male fastener 38, bracket portion 74 and female fastener 44 above the upper ends 22 of respective rails 20, 20′ so that the female fasteners are aligned with the female fastener portions 32 of the first slots. The subassembly 262 of fasteners and accessory selected from the first family of accessories then may be inserted into the first slots 30 of the rails 20, 20′, the accessory may be moved to any vertical position on the rails 20, 20′, and then releasably attached at the selected position to the rails by tightening the first fastener subassemblies 45.

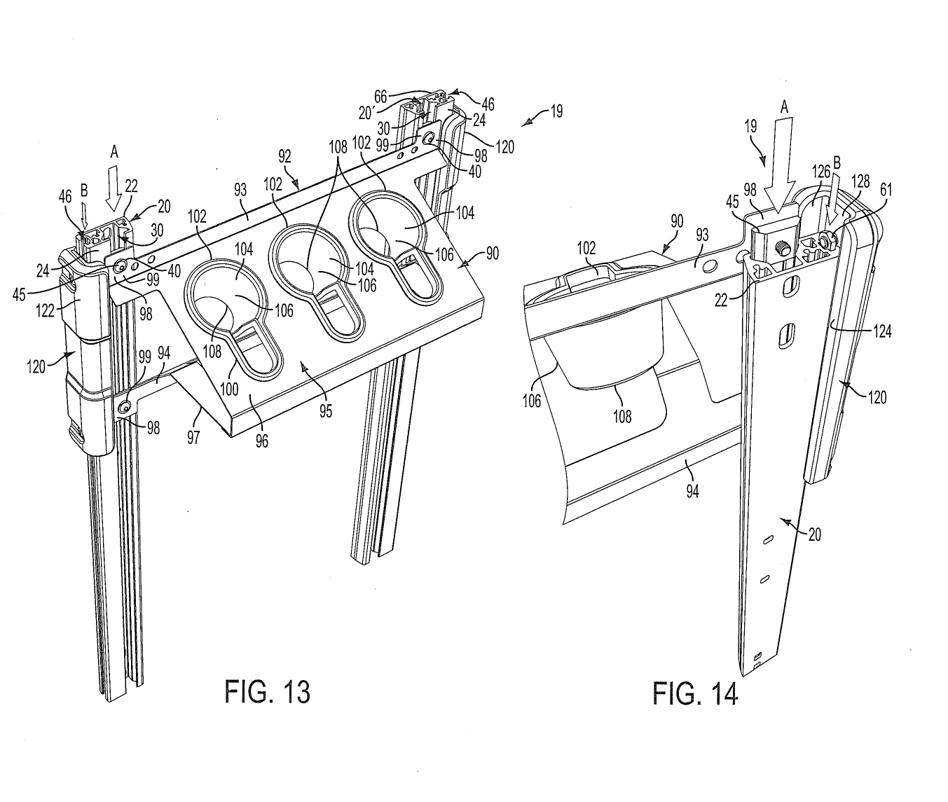

The first family of mobile tool cart accessories of the present invention also includes one embodiment of a tool holster 90, for example, a power tool holster, as shown in FIGS. 13, 14, 16, and 21. The tool holster 90 of the present invention is ergonomically designed to snugly engage a power tool 91 (see FIG. 1), while allowing the weight of the power tool to assist in maintaining it in place in the holster. Referring to FIGS. 13 and 14, the tool holster 90 includes a frame 92 adapted to be connected to the vertical surface and defining a first horizontal bracket 93 and a second horizontal bracket 94 parallel to the first horizontal bracket, and spaced downwardly a predetermined distance from the first horizontal bracket. The first and second horizontal brackets 93, 94 support a tool support portion 95. The tool support portion 95 defines a first member 96 angled outwardly and downwardly from the first horizontal bracket 93, and further defines a second member 97 extending from a lower edge of the first member towards, and being connected to, the second horizontal bracket 94. The horizontal brackets 93, 94 each define two ends 98, each of which in turn includes a connector portion 99 adapted for attachment to the vertical surface 13, such as the rails 20, 20′. The first member 96 defines a recess 100 having a configuration adapted to receive a tool. In one embodiment of the tool holster 90 of the present invention, the recess 100 is annular. Also in one embodiment of the tool holster 90 of the present invention, the frame 92, first and second horizontal brackets 93, 94, and the tool support portion 95 may together be formed as a single, sheet-metal unitary structure. A resilient insert 102, which may be formed of rubber or resilient plastic, is mounted inside the recess 100. The resilient insert 102 in turn defines a tool insertion aperture 104 having a predetermined diameter and being configured to be complementary to the configuration of the recess 100. The resilient insert 102 includes a continuous nose portion 106 tapering downwardly from the tool insertion aperture 104 a predetermined distance to an annular open end 108 having a diameter smaller than that of the tool insertion aperture, whereby a power tool 91, for example, may be inserted into the tool insertion aperture so that the tool snugly engages the nose portion. The angle that the tool support portion 95 makes with the horizontal brackets 93, 94, and the other dimensions and parameters of the tool holster 90, are selected to enable the tool to be snugly and stably held in place in the holster 90. In one embodiment of the tool holster 90 of the present invention, three tool insertion apertures 104 are provided so that up to three tools may be mounted in the holster at one time. However, if desired, fewer or greater tool insertion apertures 104 may be provided, depending upon the size of the substantially vertical surface and the configurations of the tools.

As shown in the embodiment of the tool holster 90 of FIGS. 13, 14, 16 and 21, the resilient insert 102 is smooth and uninterrupted. However, if desired, a tool holster 90′ may be provided with an insert 102 having resilient radial ribs 110, as shown in the embodiments illustrated in FIGS. 1, 6, 7, 8 and 15.

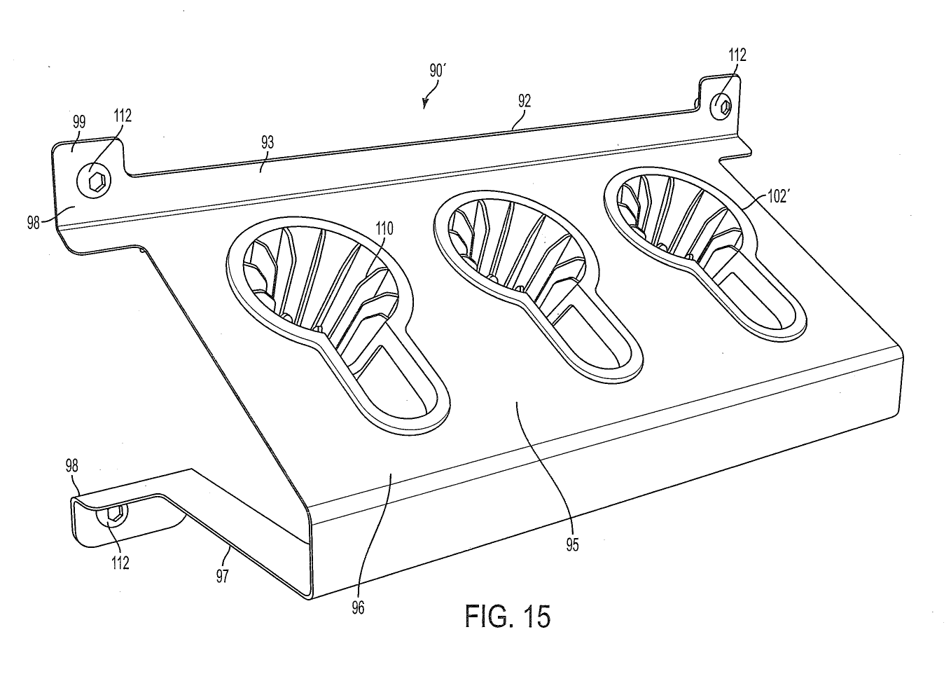

Referring again to FIGS. 13 and 14, a first male fastener 38 is inserted into each of the holster mounting holes 112 (see FIG. 15) founed in the four connector portions 99 so that the first fastener heads 40 engage respective connector portions. Female fasteners 45 are then threadedly attached to the shanks 42 of the mail fasteners 36, and, as shown by arrow A in FIG. 14 and as discussed above, the subassembly of tool holster 90 and fastener subassemblies 45 is positioned above, and then lowered into, respective first slots 30 of the rails 20, 20′. When the tool holster 90 has been positioned at the desired elevation on the rails 20, 20′, the first fastener subassemblies 45 can then be tightened, thereby releasably attaching the tool holster to the cart 10, 10′, 10″.

FIGS. 13 and 14 also illustrate the use of resilient, elongated bumpers 120 of the present invention, whose respective heights above the floor may be adjusted by slidably attaching the bumpers 120 to desired locations on the rails 20, 20 via the second slots 46. Bumpers 120 are especially helpful in an environment such as a vehicle repair shop, where cars and trucks having body portions of varying heights above the floor must be protected against accidental contact by the cart 10, 10′, 10″, as the operator navigates the cart through the array of vehicles in the shop. In one embodiment of the bumper 120 of the present invention, the bumper is formed of soft plastic, and in another, the bumper is formed of rubber. Each bumper 120 has a predetermined length, width and thickness, and includes an outside face 122 and an inside face 124. The bumper 120 defines a generally U-shaped channel 126 extending the length of the bumper and opening outwardly towards the inside face 124, thereby defining a vertical slot 128 in the inside face having a predetermined width greater than the width of the rail 20, 20′. The channel 126 also has a predetermined depth.

The bumper 120 is slidably attached to the rail 20, 20′ via second male fasteners 54, whose shanks 58 extends into the transverse entry cavity 50 of the second slot 46, and are threadedly engaged with a second female fastener 60 slidably disposed in the second slot. Thus the bumper 120 may be positioned at any location on the rails 20, 20′ and selectively tightened thereon, in the same fashion as was discussed with reference to the tool holster 90. In this case the bumper 120 and fastener subassemblies 61 are positioned above the rail upper ends 22 and aligned with the female fastener portion 48 of the second slot 46, then lowered as shown by arrow B of FIG. 14 into sliding engagement with the second slot. In one embodiment of the bumper 120 according to the present invention, two spaced fastener subassemblies 61 are used to attach the bumper to the rails 20, 20′. The depth of the bumper channel 126 is selected so that the bumper channel at least partially overlaps a side surface 24 of the rails 20, 20′. If desired, for maximum protection, the bumper channel 126 may be configured to at least partially overlap two side surfaces 24 of each rail 20, 20′. It should be noted that the rails 20, 20′, the bumper 120, and the first family of cart accessories are so configured as to permit the bumper and an accessory from the first family of cart accessories to be slidably attached to the rails independently of one another and without interfering with the ability of each to be slidable on the rails, so that both the bumper and the cart accessory may be selectively adjustably attached to the cart at one time. For example, as shown in FIGS. 13 and 14, the bumper 120 is shown positioned adjacent the tool holster 90. However, if desired, the bumper 120 and tool holster 90 may be positioned at different points on the rails 20, 20′, and not necessarily adjacent one another.

As shown in FIGS. 1-4 and 18, four bumpers 120 of the present invention have been deployed adjacent four vertical corner edges 16 of the utility cart 10, 10′, 10″ of the present invention. However, if desired, and depending for example upon the configuration of the cart 10, 10′, 10″ and the positioning of other accessories on the cart, more or fewer bumpers 120 may be deployed. At this point, inasmuch as the bumpers 120 are connected to the rails 20, 20′ by the second slots 46, the bumpers actually represent a second family of mobile tool cart accessories. However, before discussing other members of the second family of accessories, the remaining members of the first family of accessories will now be described.

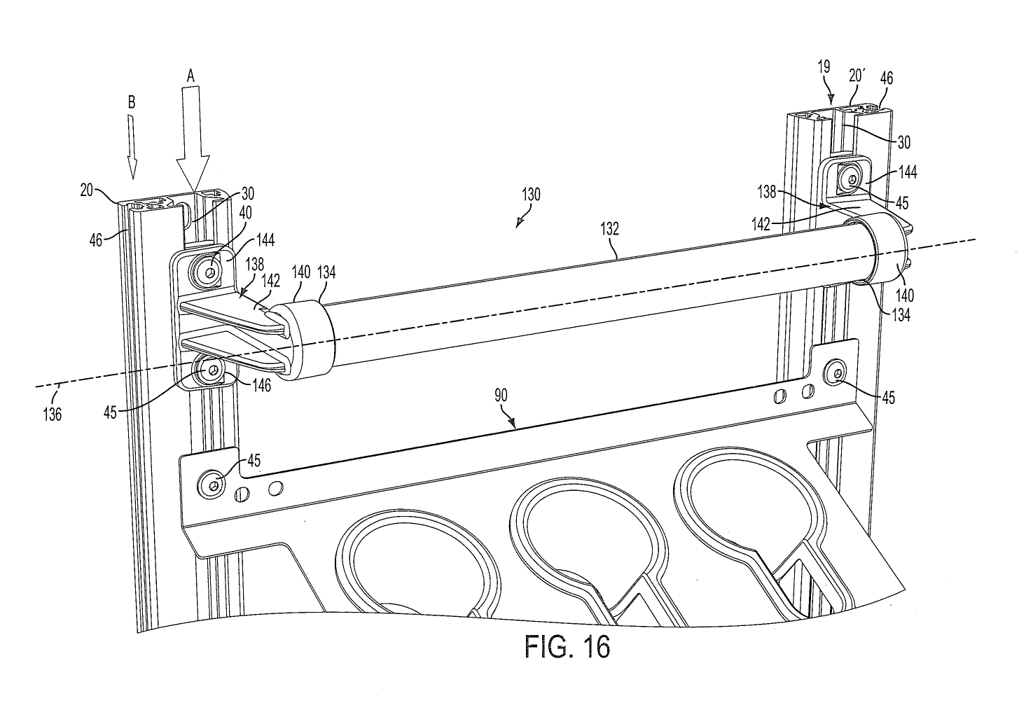

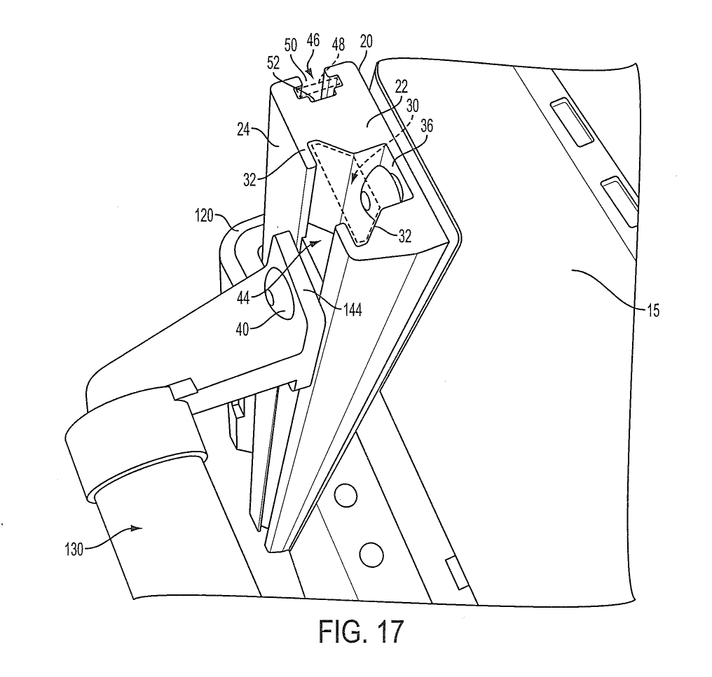

A vertically-adjustable handle accessory 130 is slidably and releasably attachable to the rails 20, 20′ via first slots 30, as shown in FIGS. 1-4, 16-19, and 21, in the same manner as was discussed above with respect to other members of the first family of mobile tool cart accessories. With particular reference to FIGS. 16 and 17, the adjustable handle 130 includes an elongated tubular member 132 having two ends 134 and defining a longitudinal axis 136. The handle 130 also includes two attachment members 138 for attaching the handle to the rails 20, 20′. The attachment members 138 are disposed adjacent each end 134 and include an annular socket 140. Each end 134 of the tubular member 132 is disposed in a respective annular socket 140 so that the tubular member is retained in the attachment member 138. Each attachment member 138 further defines a bracket member 142 extending transverse to the longitudinal axis 136 of the elongated tubular member 132 and in a first direction towards the cart 10, 10′, 10″ and away from the tubular member. The bracket members 142 in turn include flange members 144 disposed at an end of each bracket member and extending normal to the direction of the bracket member, the flange members further defining two attachment through- holes 146, each hole being disposed above and below the bracket member.

As shown in FIG. 16, the handle 130 is attached to the two rails 20, 20′ via the first slots 30 using the first fastener subassemblies 45, as was discussed above with respect to the other members of the first family of accessories. Now the operator can freely adjust the height of the handle 130 upon the cart 10, 10′, 10″ to accommodate the operator's own height as well as the presence of any other members of the first family of accessories. As illustrated in FIGS. 17, 18 and 19, the handle 130 may be freely moved up and down the rails 20, 20′ without interfering with the bumper 120, and vice-versa. As can be appreciated, the same is true with respect to other members of the second family of accessories, which are all slidably mounted on the rails 20, 20′ via the second slot 46. As was previously noted, this flexibility was also achieved in part due to the design parameters placed upon the second family of accessories, namely that the functional portions 72 of the second family of accessories are disposed inwardly of the rails 20, 20′. If desired, the handle 130 may be attached to the rails 20, 20′ on any of the four sides 15 of cart 10, 10′, 10″, and plural handles may be attached to the cart at the same time. In this respect, as shown in FIGS. 16, 17, 18, 19 and 21, plural accessories from the first family of mobile tool cart accessories may be attached to the rails 20, 20′, and consequently to the cart 10, 10′, 10″, at the same time, and, for that matter, at the same time as accessories taken from the second family of mobile tool cart accessories. For example, FIG. 21 illustrates that a parts bin 84, tool holster 90 and handle 130 may all be attached to the cart 10, 10′, 10″ at the same time.

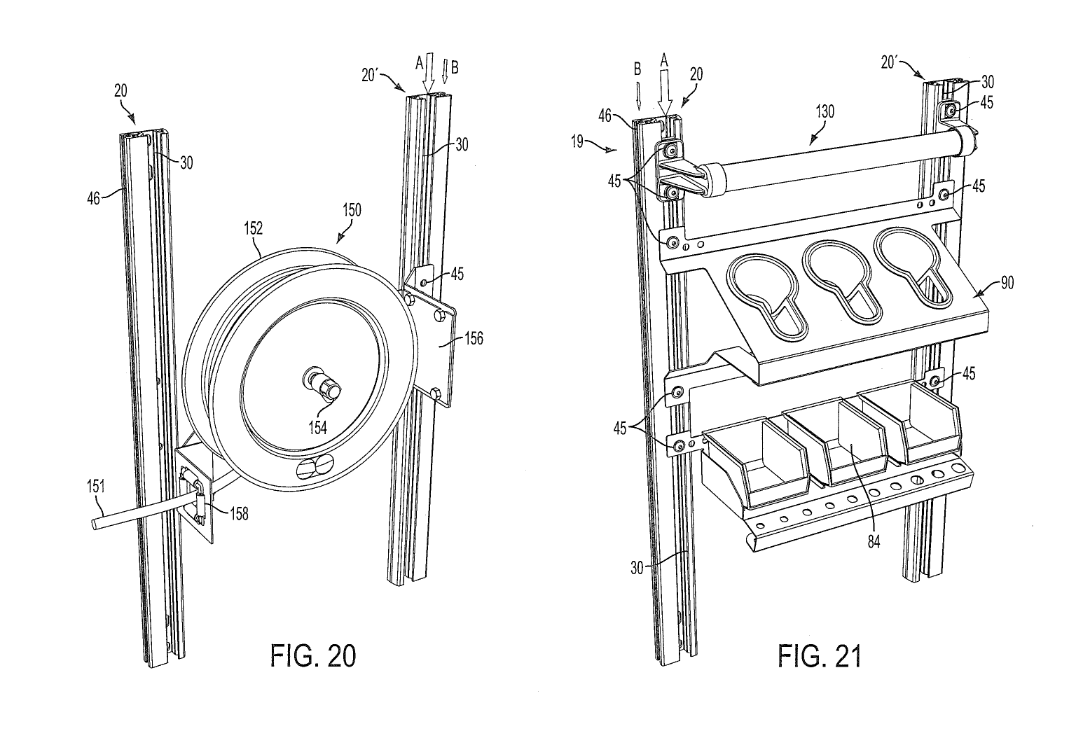

A hose wrap accessory 150, as shown in FIG. 20, is also a member of the first family of mobile tool cart accessories of the present invention. The hose wrap 150 includes a hose 151 coiled around a hose reel 152 and terminating in a hose fitting 154. The hose reel 152 is rotatably supported on a bracket 156 so that the other end of the hose 151 extends outwardly through a hose exit guide 158. The bracket 156 is slidably and releasably connected to a rail (as shown in FIG. 20, to rail 20′) via two of the first fastener subassemblies 45, in a fashion similar to that described above with reference to the other accessories taken from the first group of mobile tool cart accessories.

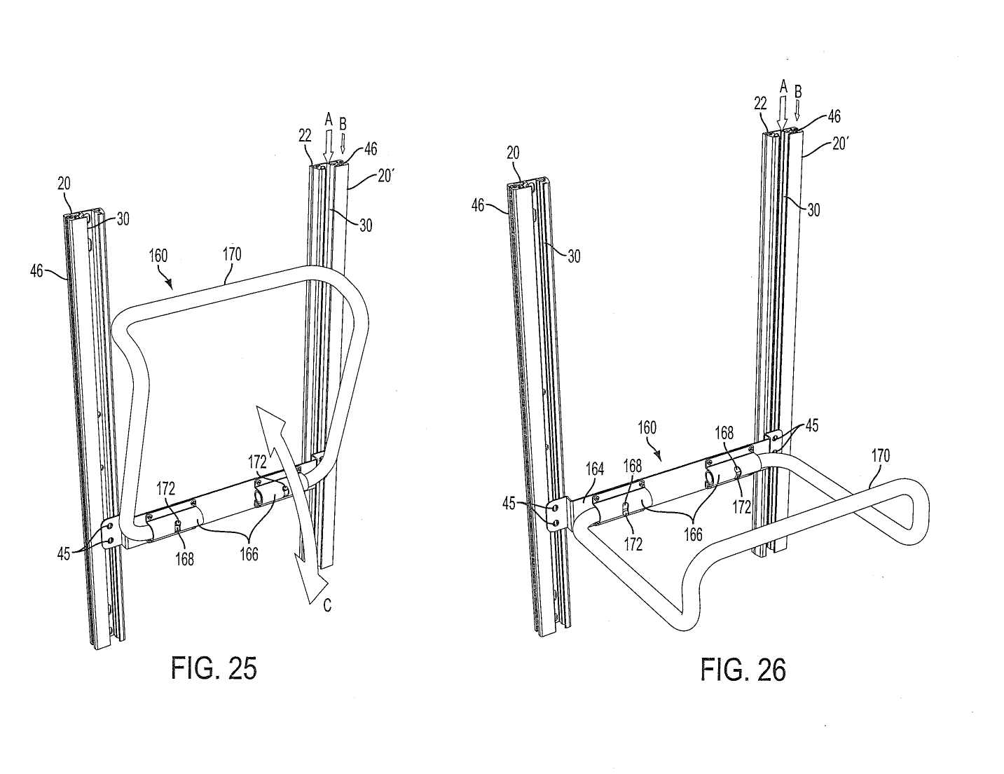

FIGS. 23-26 illustrate a foldable tire holder 160 accessory of the present invention, which is again selected from the first family of mobile tool cart accessories of the present invention. The tire holder 160 includes a horizontal member 164, which further includes two tubular attachment portions 166, each tubular attachment portion defining an arcuate slot 168. A tire holding bracket 170, which is configured to securely support a tire 162, is pivotally attached to the horizontal member 164 via the tubular attachment portions 166 for movement (as indicated by the arrow C in FIGS. 23 and 25) between a deployed position as shown in FIGS. 24 and 26, and a folded position, shown in FIGS. 23 and 25. Pins 172 are mounted on the tire holding bracket 170 for movement within the arcuate slots 168 formed in the tubular attachment portions 166. The orientation and configurations of the slots 168 and the dimensions of the pins 172 are selected to cause the tire holding bracket 170 to stay in the folded position until the operator deploys the tire holding bracket against the resistance presented by the coaction of the pins in the arcuate slots. Other means for temporarily maintaining the tire holding bracket 170 in the folded position will no doubt be apparent to one of ordinary skill in the art.

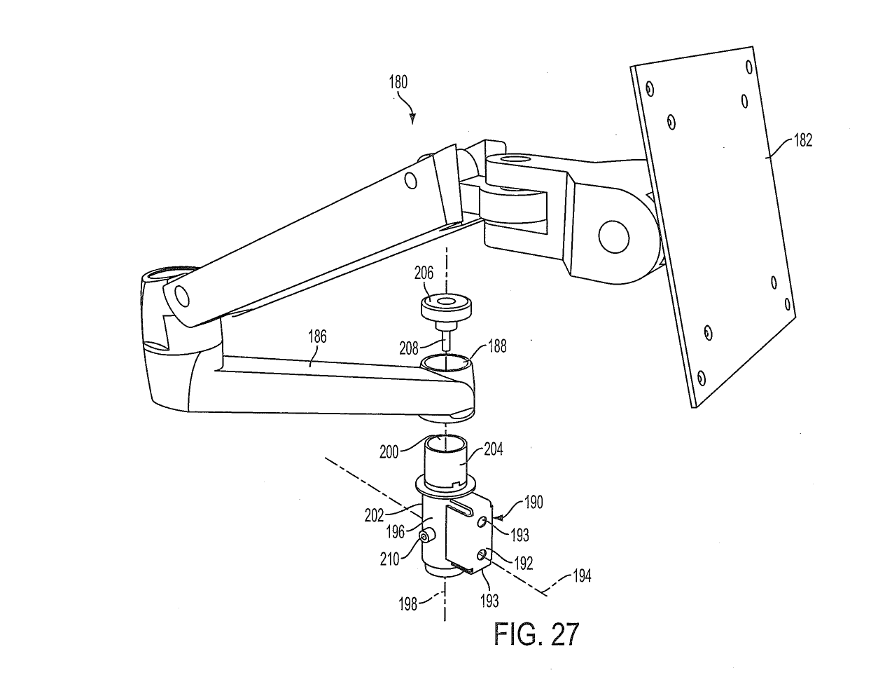

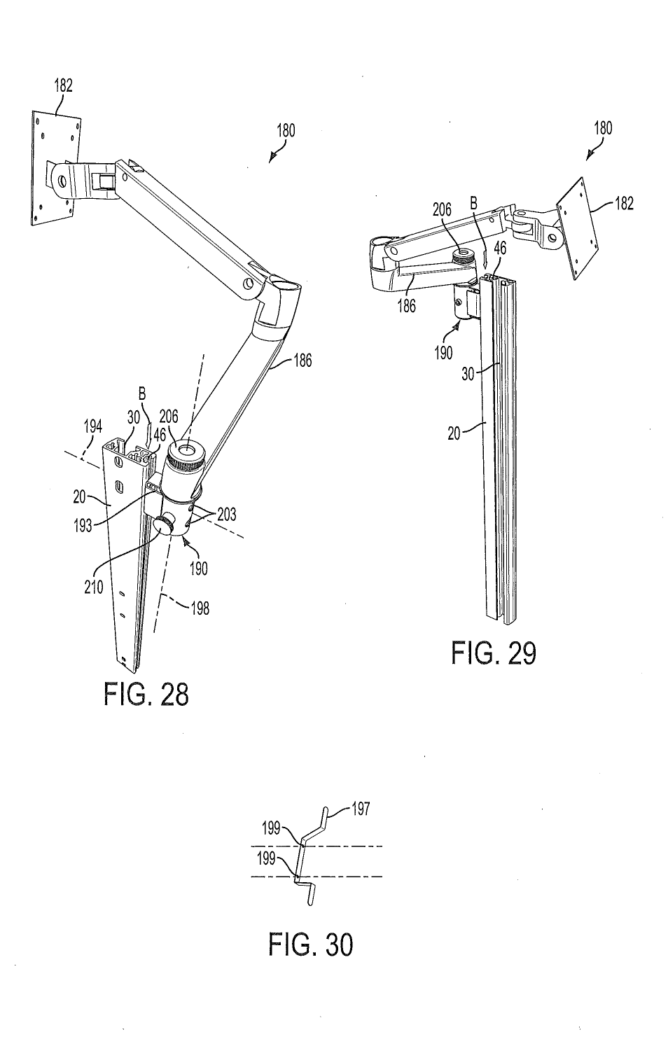

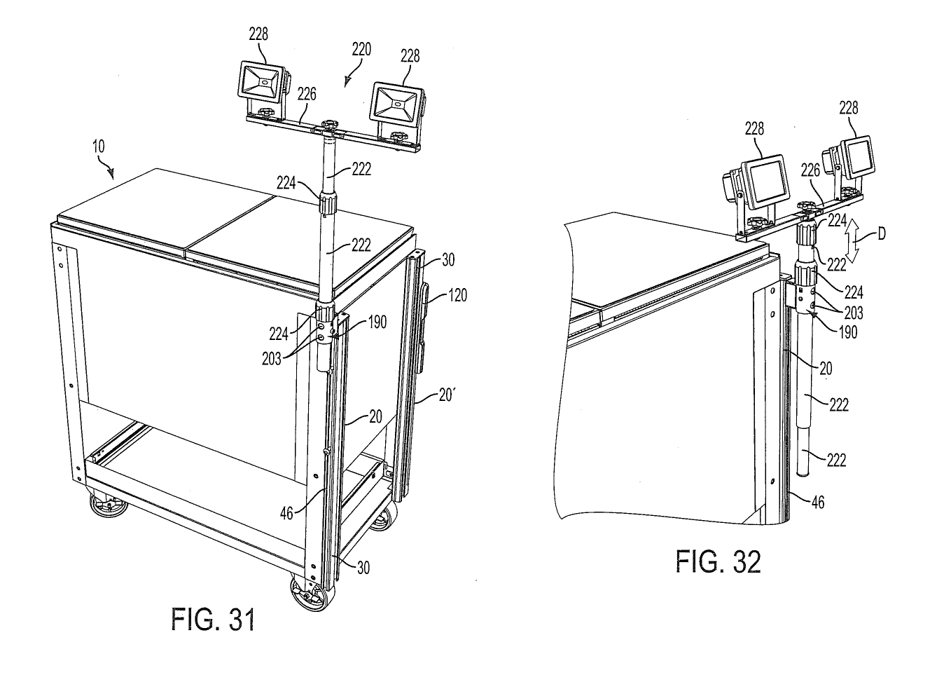

Moving again to the second family of accessories for the mobile utility cart 10, 10′, 10″ of the present invention, an articulated arm system 180 having a diagnostics tablet mounting pad 182, such as is used to mount a vehicle diagnostics tablet 184 (see FIG. 1), is illustrated in detail in FIGS. 27-29. Another member of the second family is a cord wrap 197, which is shown in FIG. 30. Still another member of the second family is an adjustable lighting fixture 220, shown in FIGS. 31 and 32. All are ultimately attached to the rails 20, 20′ via the second fastener subassemblies 61 coacting with the second slot 46, in the same manner as was described above with respect to the bumper 120 of the present invention. However, the foundation for maximizing the degrees of freedom of the operation of the articulated arm system 180 and the adjustable lighting fixture 220 is a pivot mounting module 190, which itself is connected to the rails 20, 20′ via the second fastener subassemblies 61 coacting with the second slot 46, as noted above.

Referring to FIGS. 27-29, the pivot mounting module 190 includes a rail attachment portion 192 defining two vertically-aligned attachment holes 193, and an axis 194 normal to the rails 20, 20′, The pivot mounting module 190 further includes a pivot portion 196 defining an axis 198 normal to the axis 194 of the rail attachment portion 192. The pivot portion 196 includes a cylinder 200 coaxial with the pivot portion axis 198, the cylinder defining a rail mounting cylinder 202 and an accessory mounting cylinder 204, the accessory mounting cylinder being slidably disposed in, and being coaxial with, the rail mounting cylinder 202. The rail mounting cylinder 202 defines two vertically-aligned access holes 203, also axially aligned with respective attachment holes 193. The accessory mounting cylinder 204 includes an internal female fastener, such as a “star nut”, (not shown) which is mounted inside the accessory mounting cylinder so that the star nut is coaxial with the pivot portion axis 198. A tightening fastener 210, such as a set screw, is disposed in a threaded aperture in the wall of the pivot portion 196 so that is engageable with the accessory mounting cylinder 204, thereby making it possible for the operator to rotate the accessory mounting cylinder to a desired orientation relative to the rail mounting cylinder 202, and then to tighten the tightening fastener 210 to releasably retain the accessory mounting cylinder in that desired orientation.

The pivot mounting module 190 is slidably attached to the rails 20, 20′ using two of the second fastener subassemblies 61 which coact with the second slot 46, as was described above with reference to the bumper 120. In this case, the second male fastener shanks 58 protrude outwardly through the attachment holes 193 in the rail attachment portion 192 in a direction towards the rails 20, 20′, the respective second male fastener heads 56 being accessible via the two aligned access holes 203. Accordingly, the pivot mounting module 190 may then be positioned above the rail upper end 22 so that the second fastener subassemblies 61 are aligned with the second slot 46, and, as was discussed above with respect to the bumper 120, the pivot mounting module may be slidably disposed on the rails 20, 20′ until the operator releasably tightens the fastener subassemblies 61.

Still referring to FIGS. 27-29, the articulated arm system 180 of the present invention includes a mounting arm 186 defining at one end thereof a mounting arm cylinder 188 coaxially aligned with the pivot portion axis 198 and rotatably disposed upon the accessory mounting cylinder 204. A retainer cap 206 having a threaded stem 208 is disposed on top of the mounting min cylinder 188 so that the threaded stem engages the interior female fastener located inside the accessory mounting cylinder 204. This makes it possible to selectively retain the articulated arm system 180 of the present invention upon the accessory mounting cylinder 204. As a result, if desired, by loosening the tightening fastener 210, the operator may remove the articulated arm system 180 of the present invention together with the accessory mounting cylinder 204, and place it in storage. Now the pivot mounting module 190 is ready for mounting either the articulated arm system 180 or another accessory where pivoting is a desirable feature. Thus, as can be seen in FIG. 1, the use of the pivot mounting module 190 in conjunction with the rail second slot 46 provides an operator with exceptional flexibility in the placement and use of a wide range of utility cart accessories of the present invention, without being concerned that the position or operation of an accessory from the second family of utility cart accessories will interfere with the position or operation of an accessory from the first family of utility cart accessories, and vice-versa.

The lighting fixture 220, as shown in FIGS. 31 and 32, is another example of an accessory selected from the second family of mobile utility cart accessories that benefits from the flexibility and wide range of motion afforded to the user by the pivot mounting module 190 of the present invention. The lighting fixture 220 includes a vertical telescoping cylindrical height-adjusting system 222 mating with the accessory mounting cylinder 204 of the pivot mounting module 190 of the present invention, in the same manner as was discussed above with respect to the articulated arm system 180 of the present invention. The vertical telescoping cylindrical height adjusting system 222 includes a system of rotary clamps 224 for fixing the position of a rotatable horizontal light bracket 226 in any desired orientation relative to the mobile utility cart 10, 10′, 10″, so that lamps 228 rotatably mounted on the light bracket may illuminate any object as desired by the operator. As can be seen with reference to FIGS. 31 and 32, the lamps 228 are also pivotably attached to the horizontal lamp bracket 226.

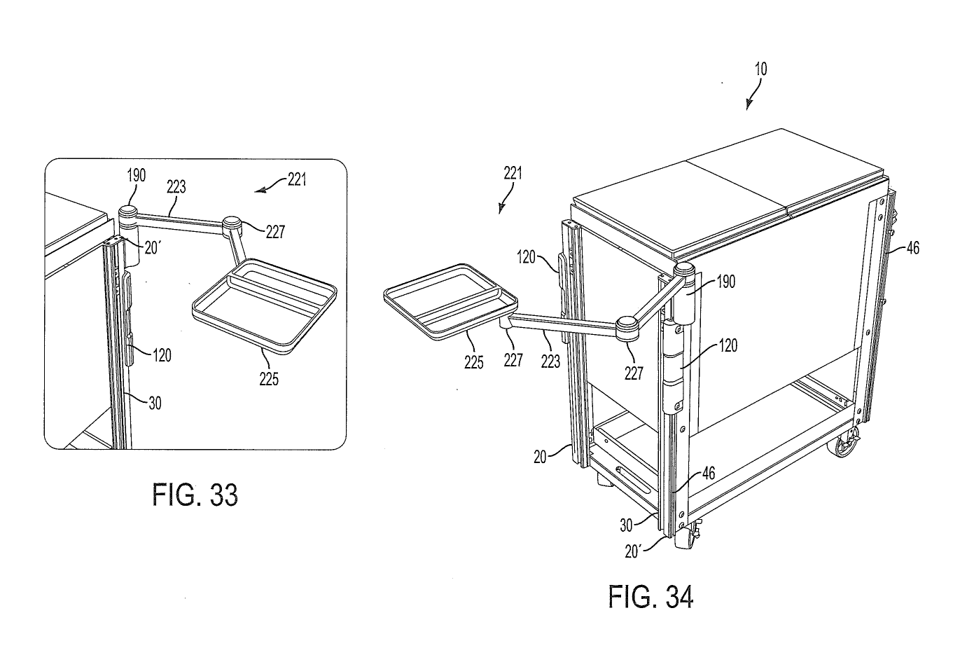

FIGS. 33 and 34 show another accessory selected from the second family of mobile tool cart accessories. An articulated tray system accessory 221 is similarly attachable to the pivot mounting module 190 in the same fashion as are the articulated arm system 180 and the lighting fixture 220 accessories of the present invention. Arm 223 supports a tray 225 through a wide range of motion facilitated by pivot joints 227.

FIG. 30 shows the cord wrap 197 of the present invention, which defines two attachment holes 199, by which the cord wrap is attachable to the rails 20, 20′ via the second fastener subassemblies 61 coacting with respective second slots 46, in the same manner as was discussed above with respect to the bumper 120 of the present invention.

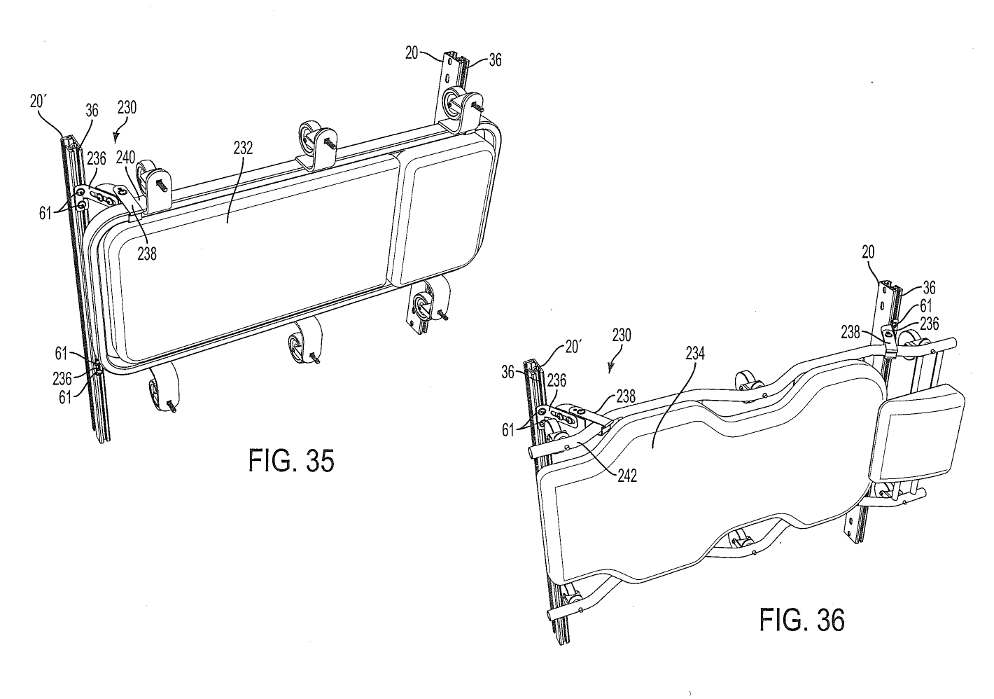

The accessory mounting system 19 of the present invention is also capable of mounting larger accessories to the mobile tool cart 10, 10′, 10″ of the present invention. For example, wheeled creepers are ubiquitous in motor vehicle repair facilities. They allow the operator to slide under the chassis of the vehicle upon which they are working. Accordingly it would be handy to have a creeper available at the mobile utility cart so that the operator would not have to constantly leave the job they're working on to retrieve a creeper. To that end, a third family of utility cart accessories includes a set of creeper hangers 230 which are operatively associated with rails 20, 20′, as shown in FIGS. 35-38. In this case the creeper hangers 230 are positioned so that creepers can be attached adjacent the long sides of the mobile utility cart 10, 10′, 10″. This is made possible by the unique structure of the rails 20, 20′ of the present invention, which, when attached to the cart 10, 10′, 10″ of the present invention adjacent each of the four vertical corner edges 16, as set forth above, present their respective second slots 46 so that they are facing outwardly from the cart on either side of a long side 15 of the cart.

As shown in FIGS. 35 and 36, the creeper hangers 230 of the present invention are capable of attaching two different types of creepers to the mobile utility cart 10, 10′, 10″ of the present invention. FIG. 35 illustrates a creeper 232 with a rectangular frame, while FIG. 36 illustrates a creeper 234 with a tubular frame. Each frame presents a different orientation to the creeper hanger 230 of the present invention, which is nevertheless adapted to selectively engage and hold either type of creeper 232, 234.

The creeper hanger 230 includes a rail mounting portion 236 having an arm defining an adjustment slot 237, and a creeper mounting portion 238 which, as noted above, is adapted to be selectively releasably attachable to a rectangular frame portion 240 of creeper 232, as well as to a tubular frame portion 242 of creeper 234. The rail mounting portions 236 are slidably releasably attachable to the rails 20, 20′ via the coaction of two of the second fastener subassemblies 61 with each second slot 46, as was described above with reference to the attachment of bumper 120.

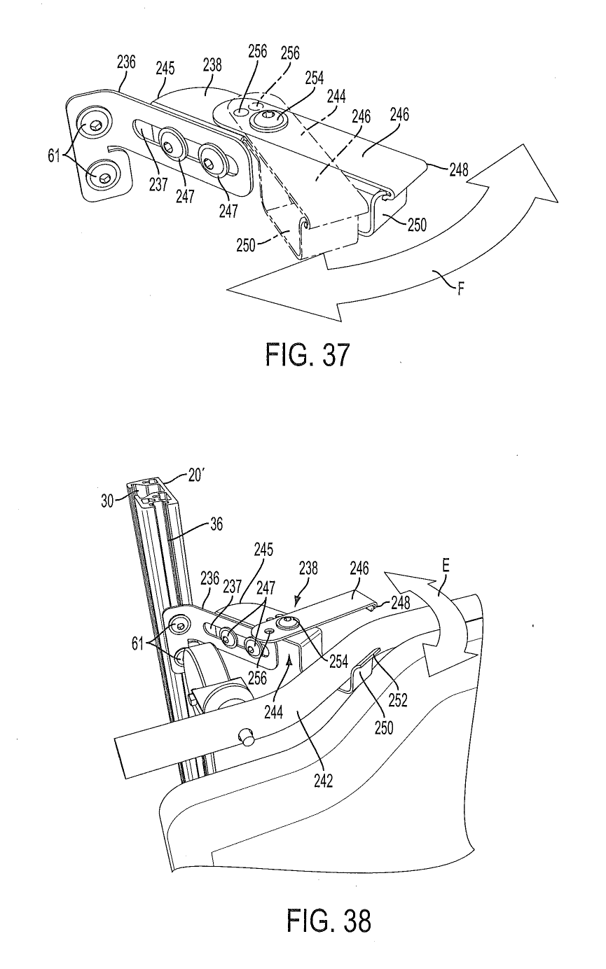

As shown in FIGS. 37 and 38, the design of the creeper mounting portion 238 of the creeper hanger 230 of the present invention performs two different functions. The first, illustrated in FIG. 37, with further reference to FIGS. 35 and 36, is generated by the provision of a swivel clamp subassembly 244, which is pivotally attached to a swivel clamp subassembly platform 245, so that the entire swivel clamp subassembly can be oriented in either of two positions as shown by arrow F in FIG. 37, the angled position shown in FIG. 37 being associated with the creeper 232 having a rectangular frame as shown in FIG. 35, and the straight position shown in FIG. 37 being associated with the creeper 234 having a tubular frame as shown in FIG. 36. The second function, as shown in FIG. 38, is the ability to releasably clamp a respective rectangular or tubular frame portion 240, 242. Here a clamp arm 246 defining a clamp arm hook 248 is itself pivotally attached to the creeper mounting platform 238 so that it can be swung away from, or over, a U-bracket 250 defining a U- bracket hook 252. The clamp aim 246 is pivotally attached to the U-bracket 250 via a pivot pin 254. The clamp arm 246 is shown in FIG. 38 as being disengaged from the U-bracket 250. The U- bracket 250 is made of resilient or spring material so that, when the operator wishes to clamp the creeper 232, 234 to the creeper hanger 230, the clamp arm 246 is pivoted to the position shown in FIG. 37, as shown by arrow E in FIG. 38. This permits the clamp arm hook 248 to engage the U-bracket hook 252, the U-bracket hook having been bent inwardly slightly to accept engagement with the clamp arm hook 248. The coaction of the clamp arm hook 248 with the U-bracket hook 252 maintains the creeper mounting portion 238 in the clamped state until the operator is ready to disengage the creeper 232, 234. The swivel clamp subassembly platform 245 and the clamp arm 246 define respective padlock holes 256 so that the creepers 232, 234 may be locked on the creeper hangers 230.

Thus the modular accessory attachment system 19 of the present invention provides exceptional flexibility in attaching accessories from three different families and of many different types to the mobile utility cart 10, 10′, 10″ of the present invention. Its design also makes it easy for the accessories to be attached, and then readily positioned at any desired elevation on the cart, and, if desired, to be subsequently easily replaced with other accessories or repositioned on the cart. Furthermore, the modular accessory attachment system 19 of the present invention permits several accessories to be attached to the cart 10, 10′, 10″ at the same time, while also permitting accessories from one family to be moved independently of the accessories from another family, without interfering with the operation or position of either.

This flexibility nevertheless can be produced at minimum cost. By using one basic design for the rails 20, 20′, only two types of aluminum extrusion need be manufactured and stocked. Furthermore, no special clamping systems are required. The modular accessory attachment system 19 of the present invention uses just two types of fastener subassemblies 45, 61, which are inexpensive, to say the least. The resulting coaction of the accessories with the continuous, uninterrupted rails 20, 20′ provides a user-friendly and flexible yet inexpensive means for equipping a mobile utility cart with accessories.

The above-described embodiments are not to be construed as limiting the breadth of the present invention. As noted previously, the term “cart” also includes boxes and other conveyances used in and around work areas. Also, modifications and other alternative constructions will be apparent that are within the spirit and scope of the invention as defined in the appended claims. For example, a person of ordinary skill in the art will no doubt be able to envision a whole range of extensions to and variations of accessories which fall within the spirit and scope of the invention as defined in the appended claims.

What is claimed is:

1. A modular accessory attachment system for attaching accessories to a substantially vertical surface, comprising:
two parallel vertical rails spaced a predetermined distance apart and connectable to the surface;
a first accessory defining a horizontal component having a predetermined width substantially spanning the distance between the two rails;
the first accessory horizontal component having two ends, and further defining a first rail interface disposed adjacent each end and operatively associated with respective rails;
each rail being continuous and uninterrupted and maintaining a predetermined cross-section throughout the length of the rail;
each rail defining a first longitudinal slot having a first female fastener portion having a predetermined width, a first transverse entry cavity opening outwardly of the rail, and a first fastener clearance portion axially aligned with the transverse entry cavity;
the first transverse entry cavity having a predetermined width less than the width of the female fastener portion;
the first accessory horizontal component including a portion extending across each rail transverse entrance cavity;
each first rail interface including a first male fastener having a head and a shank, and further including a first female fastener having a cross-section complementary to the cross-section of the first slot female fastener portion, and being slidably disposed in the first slot female fastener portion;
the first male fastener shank extending through the first accessory horizontal component so that the head engages the first accessory horizontal component, and further extends through the transverse entry cavity and into the first female fastener; wherein
the first female fastener being threadedly engageable with the first male fastener shank so that the first accessory may be selectively releaseably attached to the rails and positioned at any vertical location on the rails; and wherein
each rail defining a second longitudinal slot oriented transverse to the first slot; and further comprising:
a second accessory defining a second rail interface operatively associated with the rail second slot;
the second slot defining a second female fastener portion having a predetermined width and cross-section, a second transverse entrance cavity opening outwardly of the rail, and a second fastener clearance portion axially aligned with the transverse entrance cavity;
the second slot transverse entrance cavity having a predetermined width less than the second female fastener portion width;
the rails being disposed on the vertical surface so that respective second slot entrance cavities face outwardly in opposite directions from one another;
the second rail interface including a second male fastener having a head and a shank;
the second rail interface further including a second female fastener having a cross-section complementary to the cross-section of the second slot female fastener portion, and being slidably disposed in the second slot female fastener portion;
the second male fastener shank extending through the second accessory so that the second male fastener head engages the second accessory, and further extends through the second transverse cavity, and into the second female fastener; and
the second female fastener being threadedly engageable with the second male fastener shank so that the second accessory may be selectively positioned at any vertical location on the rail, and further may be releasably attached to the rail.

2. The modular accessory attachment system claimed in claim 1, wherein:
the first slot female fastener portion defining a trapezoidal cross-section, the trapezoid having a short side and an opposing long side;
the long side extending across the first slot transverse entry cavity; and
the first female fastener having a trapezoidal cross-section complementary to the first slot female fastener portion.

3. The modular accessory attachment system claimed in claim 1, wherein:
the second slot defining, in place of the second female fastener portion, a second male fastener head portion having a predetermined width and cross-section;
the second male fastener having a head having a cross-section complementary to the cross-section of the second slot male fastener head portion, and being slidably disposed in the second slot male fastener head portion;
the second male fastener shank extending from the head through the second transverse entrance cavity, through the second accessory, and into the second female fastener; and
the second male fastener shank being threadedly engageable with the second female fastener so that the second female fastener engages the second accessory, whereby the second accessory may be selectively positioned at any vertical location on the rails, and further may be releasably attached to the rails.

4. A tool holster attachable to a substantially vertical surface, comprising:
two spaced parallel vertical rails attachable to the substantially vertical surface;
a frame adapted to be connected to the rails and defining a first horizontal bracket mounting a tool support portion;
the tool support portion defining a first member angled outwardly and downwardly from the horizontal bracket;
the first member defining a recess having a configuration adapted to receive a tool;
a resilient insert mounted inside the recess;
the resilient insert having a tool insertion aperture having a predetermined diameter and being configured to be complementary to the recess configuration;
the resilient insert having a continuous nose portion tapering downwardly from the tool insertion aperture a predetermined distance to an open end, the open end having a diameter smaller than the tool insertion aperture; whereby
a tool may be inserted into the tool insertion aperture so that the tool snugly engages the nose portion.

5. The tool holster claimed in claim 4, wherein:
the frame further defining a second horizontal bracket parallel to the first horizontal bracket and spaced downwardly a predetermined distance from the first horizontal bracket;
the tool support portion further defining a second member extending from a lower edge of the first member towards, and being connected to, the second horizontal bracket;
each horizontal bracket having two ends and a predetermined length;
each end defining a connector portion adapted for attachment to respective rails;
the frame, first and second horizontal brackets, and tool support portion forming a single unitary structure; and
the respective first and second horizontal bracket connector portions being selectively slidably attachable to the spaced parallel vertical rails so that the tool holster may be attached to the rails at any vertical position along the rails.

6. The tool holster claimed in claim 5, wherein the rails are attached to a utility cart.

7. The tool holster claimed in claim 5, wherein:
the first member defining plural recesses, each having a configuration adapted to receive a power tool;
a resilient insert being configured to be complementary to the plural recesses and being mounted in each recess; whereby
plural power tools may be inserted into respective resilient inserts so that the power tools snugly engage the inserts.

8. A utility cart, comprising:
a generally rectangular support structure having four vertical sides and mounted on wheels;
the four vertical sides defining four vertical edges having a predetermined height;
two parallel vertical rails, each connected to the cart adjacent a respective vertical edge;
each rail being continuous and uninterrupted, having a predetermined length, and defining a first longitudinal slot having a predetermined cross-section and a predetermined width;
the first slot opening outwardly of the rail in a direction away from the cart and in a first orientation, and further defining a first transverse entry cavity having a predetermined width less than the width of the first slot;
each rail defining a second longitudinal slot having a predetermined cross-section and a predetermined width;
the second longitudinal slot having a predetermined cross-section and a predetermined width;
the second slot opening outwardly of the rail in a direction away from the cart and in a second orientation, and defining a second transverse entry cavity having a predetermined width less than the width of the second slot, and further being angularly rotated from the first orientation by substantially 90°;
the rails being disposed on the cart so that respective transverse entry cavities of the second slots open in a direction away from the cart and opposite to one another;
a first family of cart accessories adapted to be selectively adjustably attached to the cart via the first slot in the parallel vertical rails; and
a second family of cart accessories adapted to be selectively adjustably attached to the cart via the second slot in any of the vertical rails.

9. The utility cart claimed in claim 8, further comprising:
two additional parallel vertical rails as configured in claim 8 being connected to the cart, each adjacent one of the two remaining corner edges; so that
the respective second orientations are parallel, and so that the second longitudinal slots are oriented away from the cart and opposite to one another; and further comprising:
a third family of cart accessories adapted to be selectively adjustably attached to the cart via the second slot in each of two parallel rails.

10. The utility cart claimed in claim 8, wherein plural accessories from any of the families of cart accessories may be adjustably attached at one time via the slots in the rails.

11. The utility cart claimed in claim 10, wherein an accessory from the first family of cart accessories and an accessory from the second family of cart accessories may be respectively adjusted freely up and down the rails without the accessories from the first family interfering with the accessories from the second family, and vice versa.

12. The utility cart claimed in claim 8, wherein:
each accessory from the first family of cart accessories defining a functional portion and a bracket portion;
the functional portion and the bracket portion being formed as a single unitary structure;
the functional portion having a first predetermined width and two ends;
the bracket portion having a second predetermined width greater than the first predetermined width and being disposed adjacent a top of the functional portion;
the bracket portion defining two ends extending outwardly of the functional portion ends;
each bracket portion end defining an attachment hole;
the distance between centerlines of the first slots being substantially equal to the distance between centerlines of respective attachment holes; and further comprising:
a male fastener having a head, and further having a shank disposed in the mounting holes so that the head bears against the bracket portion and the shank is disposed within the first slot transverse entrance cavity;
a female fastener having a cross-section complementary to the rail first slot cross-section and being slidably disposed therein;
the female fastener being threadedly engageable with the male fastener; whereby
the accessories from the first family of cart accessories may be selectively and releasably attached to the rails at any vertical position on the rails.

13. The utility cart claimed in claim 8, wherein:
the first longitudinal slot having a trapezoidal cross-section;
the first family of cart accessories each including a horizontal mounting bracket having two ends;
the mounting bracket defining a mounting hole proximate each end; and further comprising:
a first male fastener having a head and a shank, and being adapted to be inserted in each mounting hole so that the head abuts the mounting bracket;
a first female fastener defining a trapezoidal cross-section complementary to the first slot cross-section and being slidably disposed within the first slot; wherein
the first female fastener being threadedly engageable with the first male fastener shank; whereby
the shank of each first male fastener extends into the transverse access cavity of the first slot, and threadedly engages the first female fastener; and whereby
the cart accessory from the first family of cart accessories may be selectively and releasably attached to the utility cart via the rails at any vertical position along the rails; and wherein
the second slot cross-section defining a second female fastener portion;
the second family of cart accessories defining a mounting hole; and further comprising:
a second male fastener having a head and a shank;
a second female fastener slidably disposed in the second slot; wherein
the second male fastener shank being inserted in the mounting hole so that the head abuts a cart accessory selected from the second family of cart accessories and the shank is disposed in the second transverse entrance cavity, and threadedly engages the second female fastener; whereby
the cart accessory from the second family of cart accessories may be selectively attached to the mobile cart at any vertical position along the rail.

14. The utility cart claimed in claim 13, wherein:
the second slot cross-section defines a second male fastener head portion instead of the second female fastener portion; and further comprising:
a second male fastener having a head being slidably disposed in the second slot male fastener head portion so that the shank extends outwardly from the second transverse access cavity;
the male fastener further extends into a mounting hole in a cart accessory selected from the second family of cart accessories;
a second female fastener threadedly engaging the second male fastener so that the second female fastener also engages the cart accessory; whereby
the cart accessory from the second family of cart accessories may be selectively and releasably attached to the cart at any vertical position along the rail.

15. The utility cart claimed in claim 8, further comprising:
a vertically-elongated bumper adjustably vertically mounted on the rail via the second slot;
the bumper having a predetermined length, width and thickness, and further including an outside face and an inside face;
the bumper defining a generally U-shaped channel extending the length of the bumper and opening outwardly towards the inside face, thereby defining a vertical slot in the inside face having a predetermined width greater than the width of the rail;
the channel further having a predetermined depth;
the bumper being adapted to be slidably attached to the rail proximate a vertical corner edge of the cart;
the bumper being attached to the rail via a male fastener having a shank extending into the transverse entry cavity and into the second slot, the male fastener being threadedly engaged with a female fastener slidably disposed in the second slot, so that the bumper may be positioned at any location on the rail and selectively tightened on the rail; and so that
the bumper channel at least partially overlaps a side portion of the rail; and wherein
the rail, bumper and first family of cart accessories being so configured as to permit the bumper and an accessory from the first family of cart accessories to be slidably attached to the rail independently of one another and without interfering with the ability of each to be slidable on the rail, so that both the bumper and the cart accessory may be selectively adjustably attached to the cart at one time.

16. The utility cart claimed in claim 8, further comprising:
an adjustable handle operatively associated with the first elongated slots;
the handle including an elongated tubular member having two ends and defining a longitudinal axis;
an attachment member disposed adjacent each end;
each attachment member defining an annular socket;
each end of the tubular member being disposed in a respective annular socket so that the tubular member is retained in the attachment member;
each attachment member further defining a bracket member extending transverse to the longitudinal axis of the elongated tubular member in a first direction towards the cart;
each bracket member defining a flange member disposed at an end of the bracket member and extending normal to the direction of the bracket member;
the flange member defining two attachment holes, a respective hole being disposed above and below the bracket member;
the handle being attached via the first slot to the mobile utility cart so that the longitudinal axis of the tubular member is perpendicular to the rails;
the handle being attached to the rails via a male fastener disposed in each attachment hole and having a head bearing against the flange and a shank disposed through the first transverse entrance cavity and threadedly attached to a first female fastener slidably positioned in the first slot;
the first female fastener having a cross-section complementary to the cross-section of the first slot cross-section;
whereby the handle may be selectively slidably moved up and down the rails and releasably fastened at any selected vertical position thereon.

17. The utility cart claimed in claim 8, further comprising:
a pivot mounting module operatively associated with any of the rails; and
the pivot mounting module being adapted to support any one of an articulated arm system, a lighting fixture, and an articulated tray holder.

18. The utility cart claimed in claim 9, further comprising:
a creeper hanger operatively associated with the second slot in each of the two parallel rails;
the creeper hanger including a rail mounting portion and a creeper mounting portion;
the creeper mounting portion being adapted to be selectively releasably attachable to a tubular frame portion of a first creeper and a rectangular frame portion of a second creeper;
the creeper mounting portion including a swivel clamp for releasably clamping the tubular frame portion and the rectangular frame portion; and
the swivel clamp further being adapted to swivel in a plane perpendicular to the rails so that the clamp may selectively engage either a tubular frame portion or a rectangular frame portion.

19. The utility cart claimed in claim 8, further comprising:
a tire holder operatively associated with a first longitudinal slot;
the tire holder including a horizontal member defining two tubular attachment portions, each tubular attachment portion defining an arcuate slot;
the tire holder further including a tire holding bracket including two pins, each pin being captured for movement in a respective arcuate slot, whereby the tire holding bracket may be selectively positioned in a horizontal position or a vertical position, the pins and slots coacting to selectively maintain the tire holding bracket in the vertical position; wherein
the horizontal member being releasably coupled to the rail so that the tire holder can be selectively attached to the cart at any vertical position along the rail.

20. A method of attaching an accessory to the cart claimed in claim 13, comprising:
inserting a male fastener into each of the mounting holes of an accessory selected from the first family of accessories;
threading a portion of the female fasteners onto the shanks of respective male fasteners to create a fastener and accessory subassembly, leaving enough slack in the thread to maneuver the subassembly into place in the rail slots;
positioning the subassembly adjacent upper ends of respective rails so that the female fasteners are aligned with respective slots;
lowering the subassembly so that the female fasteners enter respective slots;
sliding the subassembly along the rails to a desired position; and
tightening the fasteners to releasably hold the subassembly at the desired position.
